(19) United States
(12) Patent Application Publication
(10) Pub. No.: US 2025/0215919 A1
(43) Pub. Date: Jul. 3, 2025

(54) TWIST-LOCK SOLAR MODULE CLAMP

(71) Applicant: PEGASUS SOLAR INC, Richmond, CA (US)

(72) Inventors: Erich Kai Stephan, Richmond, CA (US); Glenn Harris, Richmond, CA (US); Peter Wilke, Richmond, CA (US); Nicholas Wenzel, Richmond, CA (US); James Hsieh, Richmond, CA (US)

(21) Appl. No.: 19/083,167

(22) Filed: Mar. 18, 2025

Related U.S. Application Data
(63) Continuation of application No. 17/102,749, filed on Nov. 24, 2020, now Pat. No. 12,292,075.
(60) Provisional application No. 62/940,119, filed on Nov. 25, 2019.

(51) Int. Cl. F16B 37/04; F16B 5/00; F24S 25/60; H01R 4/44; H02S 30/00

(52) U.S. Cl. CPC F16B 37/045; F16B 5/0068; H01R 4/44; H02S 30/00; F24S 25/60; F24S 2025/6006

(57) ABSTRACT

A twist-lock clamp to attach a solar module to a rail system includes a spring between a top clamp and a t-nut, with features on the spring and top clamp to restrict rotation relative to each other. The t-nut includes features allowing rotation of about 90 degrees when the t-nut is inserted in a rail, but restrict rotation beyond about 90 degrees. The spring serves to hold the top clamp and t-nut apart while allowing the twist-lock clamp to resist sliding in the rail during installation.

### CROSS-REFERENCE TO RELATED APPLICATION

The present application is a continuation and claims the priority benefit of U.S. nonprovisional patent application Ser. No. 17/102,749, filed Nov. 24, 2020, which claims the benefit of, and priority to, U.S. Provisional Patent Application No. 62/940,119, filed on Nov. 25, 2019, the disclosures of which are incorporated herein by reference.

### BACKGROUND

Current solar mounting solutions using rails as mounting structure use clamps to secure a solar module to the rail that can be cumbersome to install. Often, there is no securing mechanism to hold the clamp into the rail prior to the solar module being installed.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1A illustrates an isometric view of a Clamp;

FIG. 1B illustrates a second isometric view of a Clamp;

FIG. 1C illustrates a third isometric view of a Clamp;

FIGS. 2A-2D illustrate the installation steps of a Clamp into a Rail;

FIGS. 3A-3D illustrate an end view of the installation steps of a Clamp into a Rail;

FIGS. 4A-4C illustrate an isometric view of a first alternative embodiment of a Clamp;

FIGS. 5A-5F illustrate the installation steps of a Clamp into a Rail;

FIGS. 6A-6C illustrate an isometric view of the installation steps of a Clamp into a Rail;

FIGS. 7 and 8 illustrate isometric views of a second alternative embodiment of a Clamp;

FIGS. 9 and 10 illustrate side and front views of a second alternative embodiment of a Clamp;

FIG. 11 illustrates an exploded view of a second alternative embodiment of a Clamp;

FIGS. 12 and 14 illustrate isometric views of a bonding strap;

FIG. 13 illustrates an isometric view of a top clamp;

FIG. 15 illustrates a view of a spring in a second alternative embodiment of a Clamp;

FIG. 16 illustrates a view of a T-nut in a second alternative embodiment of a Clamp;

FIG. 17 illustrates a view of a spring and a T-nut in a second alternative embodiment of a Clamp;

FIG. 18 illustrates an isometric view of a T-nut in a second alternative embodiment of a Clamp;

FIG. 19 illustrates a cross-section view in a second alternative embodiment of a Clamp;

FIG. 20 illustrates an isometric view of a Clamp;

FIG. 21 illustrates a fastener;

FIG. 22 illustrates two embodiments of a Bond Clip;

FIGS. 23 and 24 illustrate left and right isometric views in a third alternative embodiment of a Clamp;

FIG. 25 illustrates a side view in a third alternative embodiment of a Clamp;

FIG. 26 illustrates an isometric view in a third alternative embodiment of a Clamp;

FIGS. 27-30 illustrate isometric views of installing the second alternative embodiment in a rail; and

FIGS. 31-34 illustrate end views of installing the second alternative embodiment in a rail.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

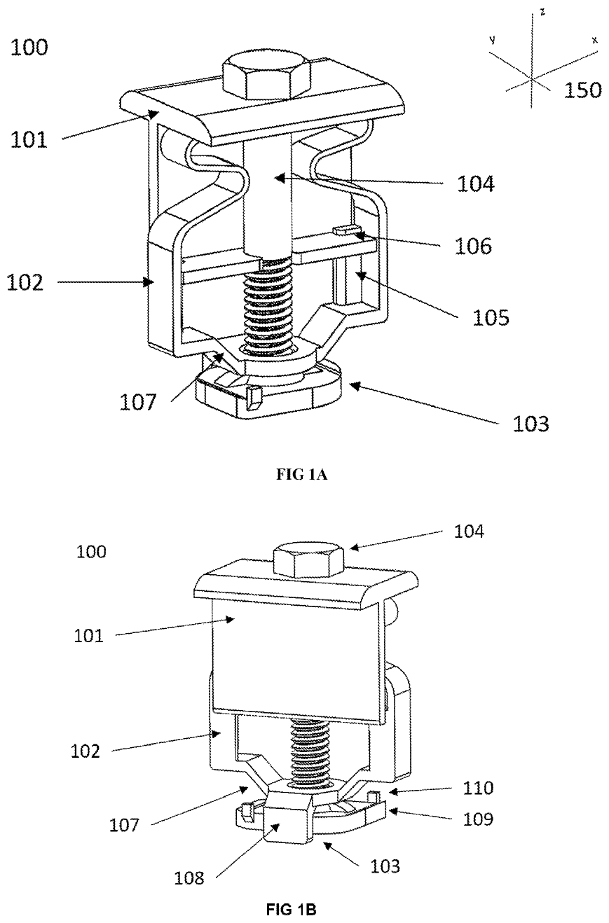

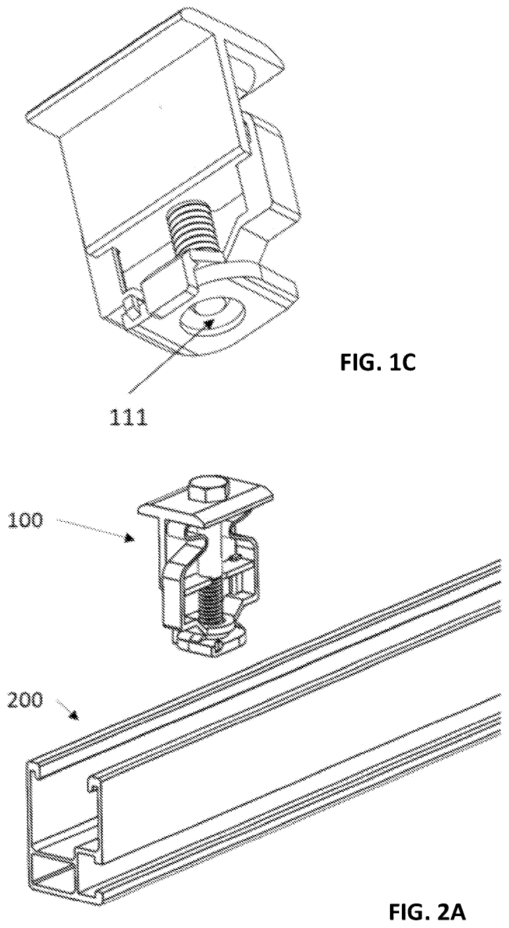

FIG. 1A depicts an isometric view of the Clamp 100. The Clamp 100 is an assembly of a Top Clamp 101, a Spring 102, a T-nut 103, and a fastener 104. The Clamp 100 is oriented in the X, Y, and Z cartesian coordinate planes 150. The fastener 104 extends through one or more apertures in the Top Clamp 101, an aperture in Spring 102, and threadably engages with T-nut 103; thereby securing all components together. Spring 102 has Ribs 105 that pass-through Rib Apertures 106 in the Top Clamp 101. The interference of Ribs 105 and Rib Apertures 106 in the X and Y direction hold the Spring 102 and Top Clamp 101 in substantially the same rotational orientation around the fastener 104 if either or both the Spring 102 or Top Clamp 101 are rotated around the fastener 104. The Ribs 105 and Rib Apertures 106 may not interfere in the Z direction so as to allow the Top Clamp 101 to compress the Spring 102 and move in the negative Z direction toward the T-nut 103 while the Spring 102 remains in substantially the same position along the Z axis. Spring 102 may have an Angled Protrusion 107. The Angled Protrusion 107 may be symmetric along the central Y-plane of the Spring 102, or it may be asymmetric. The Angled Protrusion 107 may have a flat angular surface as shown, or a curved surface. Top Clamp 101, fastener 104, and T-nut 103 may be constructed of an aluminum alloy, stainless steel alloy, carbon steel alloy, or another material with suitable strength properties. Spring 102 may be constructed using a polymer, with ultraviolet (UV) resistance and fire resistant properties.

FIG. 1B depicts a backside isometric view of Clamp 100. In this example embodiment, the Top Clamp 101 extends down in the negative Z direction and is outside of the Spring 102. Spring 102 may have one or more Spring Flanges 108 that engage with the T-nut 103 such that when the Spring 102 is rotated about the main axis of the fastener 104, the T-nut 103 rotates substantially the same amount. In this example embodiment, one Spring Flange 108 is shown to protrude down and rests substantially coincident with a side of the T-nut. T-nut 103 may have one or more T-nut Flanges 109 that protrude upward at a determined angle. The T-nut Flanges 109 may be similarly shaped and angled on the opposing edges of the T-nut 103. The T-nut 103 may have one of more Stop Flanges 110 that protrude upward in the positive Z direction. The T-nut 103 may have one or more ridges along the top surface near the T-nut Flanges 109 that can pierce a coating on a Rail 200, such as anodization or paint, such that the T-nut 103 electrically bonds with the Rail 200.

FIG. 1C depicts an underside isometric view of Clamp 100. In this example embodiment of the present invention, the T-nut has a Cone Embossment 111 formed into the T-nut 103 that provides additional threads in the T-nut 103 for the fastener 104 to threadably engage.

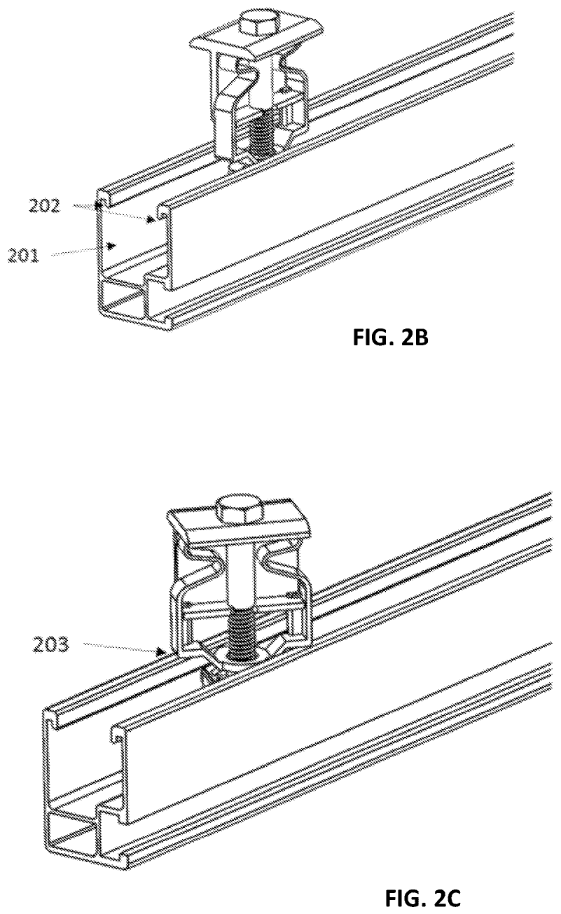

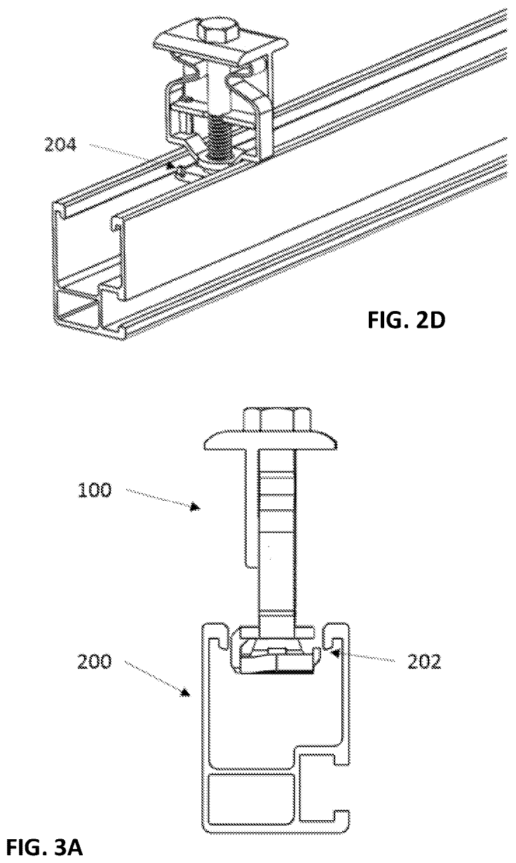

FIG. 2A depicts an isometric view of the Clamp 100 positioned over a representative section of Rail 200. In this first step representing the installation of Clamp 100 into Rail 200, the Clamp 100 is oriented with the long side of T-nut 103 substantially parallel with the length of the Rail 200.

FIG. 2B depicts a second step of the installation of the Clamp 100 into the Rail 200. In this example embodiment, the Clamp 100 has been partially inserted into the Rail Channel 201. In this example, the Clamp 100 has not been rotated around the primary axis of the fastener 104. The T-nut is positioned below the Rail Prongs 202 of the Rail 200.

FIG. 2C depicts a third step of the installation of Clamp 100 into the Rail 200. In this example next step, the Clamp 100 is rotated substantially around the primary Z axis of the fastener 104. The T-nut rotates below the Rail Prongs 202, and the Angled Protrusion 107 engages with the top edges of the Rail 200, as shown in position 203. As the Angled Protrusion 107 is engaged against the top of the Rail 200, the Spring 102 compresses the Top Clamp 101 upward, thereby forcing up the T-nut 103 to engage with the Rail Prongs 202.

FIG. 2D depicts a final fourth step in the installation of Clamp 100. In this example next step, the Clamp 100 has been rotated substantially 90 degrees relative to its initial position. The Angled Protrusion 107 is fully engaged with the top edge or the Rail 200. Stop Flanges 110 may interfere with the inside edge of the Rail 200 as shown in position 204 to prevent the Clamp 100 from rotating further.

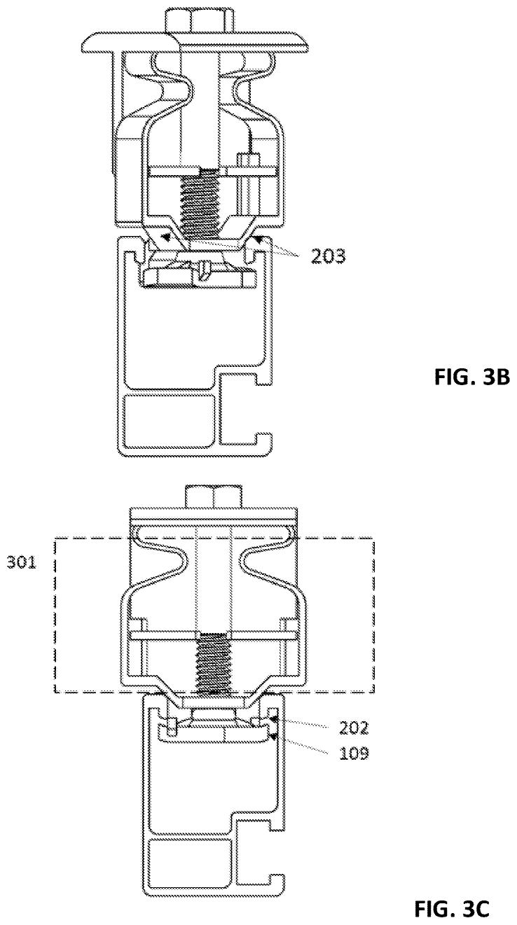

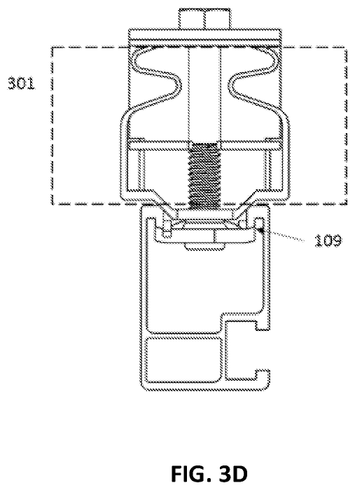

FIGS. 3A-3D depict an end view of the same installation process as described and shown in FIGS. 2A-2D. FIG. 3A depicts an end view of FIG. 2B where the Clamp 100 is partially inserted into the open channel of Rail 200. The T-nut 103 is positioned slightly below the lower points of the Rail Prongs 202. In this example step of the installation, the long side of the Clamp 100 is parallel with the long edge of the Rail 200 in either the X or Y directions.

FIG. 3B depicts an end view of FIG. 2C. In this example next step, the Clamp 100 is rotated substantially around the primary Z axis of the fastener 104. The T-nut rotates below the Rail Prongs 202, and the Angled Protrusion 107 engages with the top edges of the Rail 200, as shown in position 203. As the Angled Protrusion 107 is engaged against the top of the Rail 200, the Spring 102 compresses the Top Clamp 101 upward, thereby forcing up the T-nut 103 to engage with the Rail Prongs 202.

FIG. 3C depicts an end view of the step between FIGS. 2C and 2D wherein the Clamp 100 has rotated substantially 90 degrees from its original position and the Spring 102 is engaged with the top edges of the Rail 200, but the Spring 102 is still compressed down such that the T-nut is not yet engaged with the Rail 200 at the Rail Prongs 202. In this example embodiment, it is shown how the inside top edges of the Rail 200 are chamfered to a similar angle as the Angled Protrusion in order to coincide. A representative dimension of a Solar Module 301 is shown being positioned between the Top Clamp 101 and the top edge of the Rail 200.

FIG. 3D depicts an end view of FIG. 2D. In this example next step, the Clamp 100 has been rotated substantially 90 degrees relative to its initial position. The Angled Protrusion 107 is fully engaged with the top edge or the Rail 200. Stop Flanges 110 may interfere with the inside edge of the Rail 200 as shown in position 204 to prevent the Clamp 100 from rotating further. The T-nut Flanges 109 engage with the Rail Prongs 202 to prevent the T-nut 103 from rotating loose after installation, and to prevent the top edges of the Rail 200 from buckling outward upon being loaded in the Z direction. A representative dimension of a Solar Module 301 is shown being clamped between the Top Clamp 101 and the top edge of the Rail 200 upon the fastener 104 being threadably engaged with the T-nut 103.

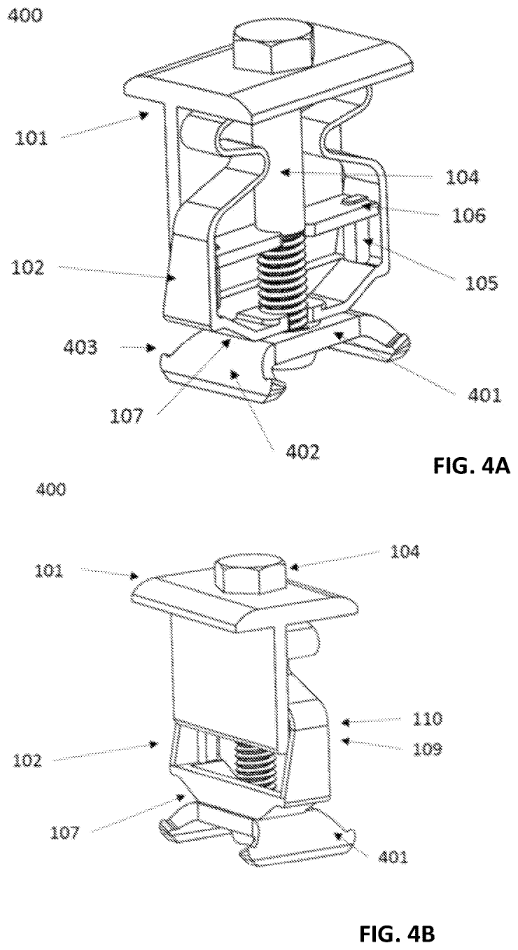

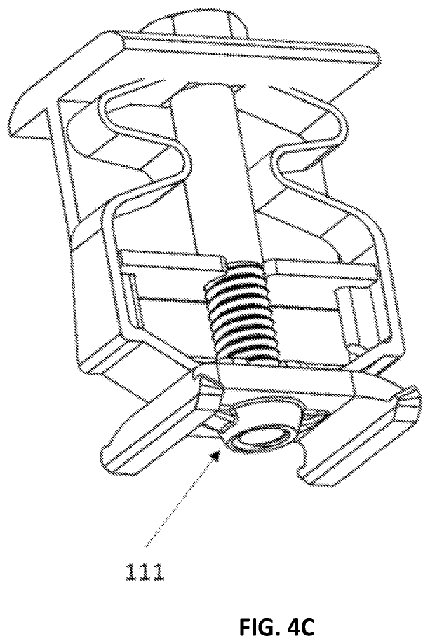

FIGS. 4 through 6 show a first alternative embodiment of the present invention. FIG. 4A depicts an isometric view of the Channel Clamp 400. The Channel Clamp 400 is an assembly of a Top Clamp 101, a Spring 102, a Channel Nut 401, and a fastener 104. The Channel Clamp 400 is oriented in the X, Y, and Z cartesian coordinate planes 150. The fastener 104 extends through one or more apertures in the Top Clamp 101, an aperture in Spring 102, and threadably engages with Channel Nut 401; thereby securing all components together. Spring 102 has Ribs 105 that pass-through Rib Apertures 106 in the Top Clamp 101. The interference of Ribs 105 and Rib Apertures 106 in the X and Y direction hold the Spring 102 and Top Clamp 101 in substantially the same rotational orientation around the fastener 104 if either or both the Spring 102 or Top Clamp 101 are rotated around the fastener 104. The Ribs 105 and Rib Apertures 106 may not interfere in the Z direction so as to allow the Top Clamp 101 to compress the Spring 101 and move in the negative Z direction toward the Channel Nut 401 while the Spring 102 remains in substantially the same position along the Z axis. Spring 102 may have an Angled Protrusion 107. The Angled Protrusion 107 may be symmetric along the central Y-plane of the Spring 102, or it may be asymmetric. The Angled Protrusion 107 may have a flat angular surface as shown, or a curved surface.

FIG. 4B depicts a backside isometric view of Channel Clamp 400. Channel Nut 401 may have one or more Nut Flanges 402 with one or more Nut Prongs 403 on the outer corners of the Nut Flanges 402. In this example embodiment, the Nut Prongs 403 are shaped to substantially contour Rail Prongs 202. The top faces of Nut Prongs 403 may be at an angle relative to the X-Y plane such that one contoured edge is in a higher position along the Z axis relative to the other top edge of the contour. The top edge will present a sharp engagement with the Rail Prongs 202 in order to pierce a coating of the Rail 200, such as anodization or paint, in order to provide an electrical bonding path between the Channel Nut 401 and the Rail 200. Channel Nut 401 may be constructed of an aluminum alloy, stainless steel alloy, carbon steel alloy, or another material with suitable strength properties.

FIG. 4C depicts an underside isometric view of Channel Clamp 400. In this example embodiment of the present invention, the Channel Nut 401 has a Cone Embossment 111 formed into the Channel Nut 401 that provides additional threads in the Channel Nut 401 for the fastener 104 to threadably engage.

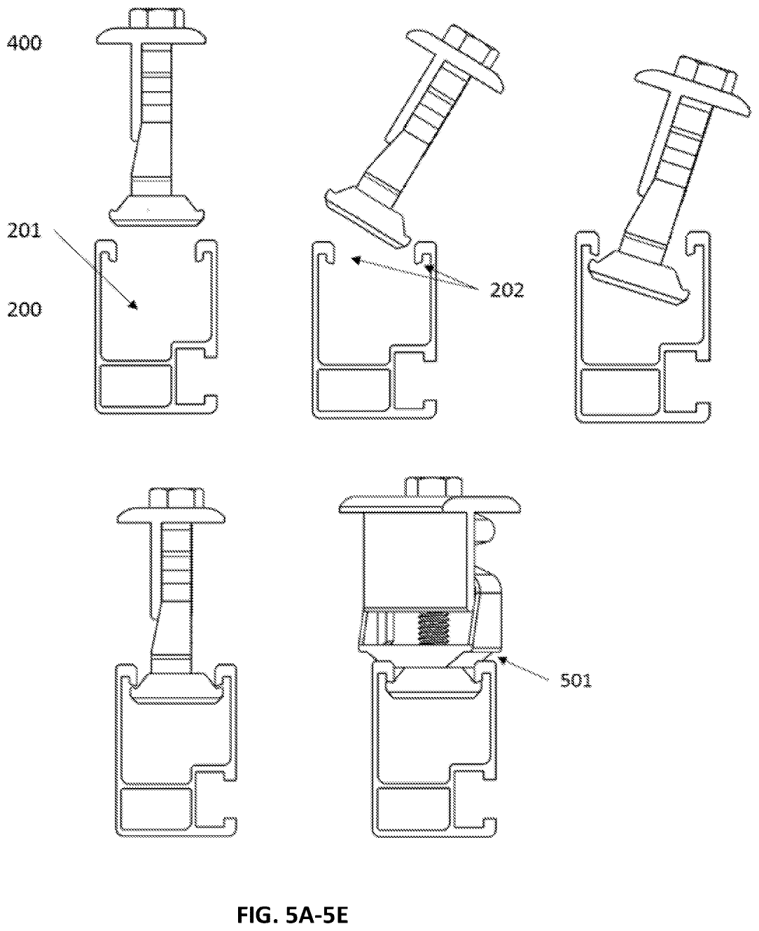

FIGS. 5A through 5F depict the end view of the installation steps for the Channel Clamp 400 into a Rail 200. FIG. 5A depicts the Channel Clamp 400 positioned over the Rail Channel 201 of the Rail 200. FIG. 5B depicts the Channel Clamp 400 angled to allow the Channel Nut 401 to fit through the top edges of the Rail 200 and into the Rail Channel 201. FIG. 5C depicts the Channel Clamp 400 lowered into the Rail Channel 201 such that all the Nut Prongs 403 are below the bottom surface of the Rail Prongs 202. In this example embodiment, the Channel Clamp 400 has been angled back towards a vertical position slightly.

FIG. 5D depicts the Channel Clamp 400 angled back to a vertical position, and elevated upwards such that the Nut Prongs 403 engage with the Rail Prongs 202. FIG. 5E depicts the Top Clamp 101 and Spring 102 rotating about the primary axis of the fastener 104 whilst the Channel Nut 401 remains substantially stationary. As the Spring 102 is rotated about the primary axis of the fastener 104, the Angle Protrusion 107 engages with the top edges of the Rail 200 at position 501.

FIG. 5F depicts a final position where the Top Clamp 101 and Spring 102 have rotated substantially 90 degrees relative to the position in FIG. 5A. The Spring 102 is now fully engaged with the top edge of the Rail 200 at position 502. A representative dimension of a Solar Module 301 is shown being clamped between the Top Clamp 101 and the top edge of the Rail 200 upon the fastener 104 being threadably engaged with the Channel Nut 401.

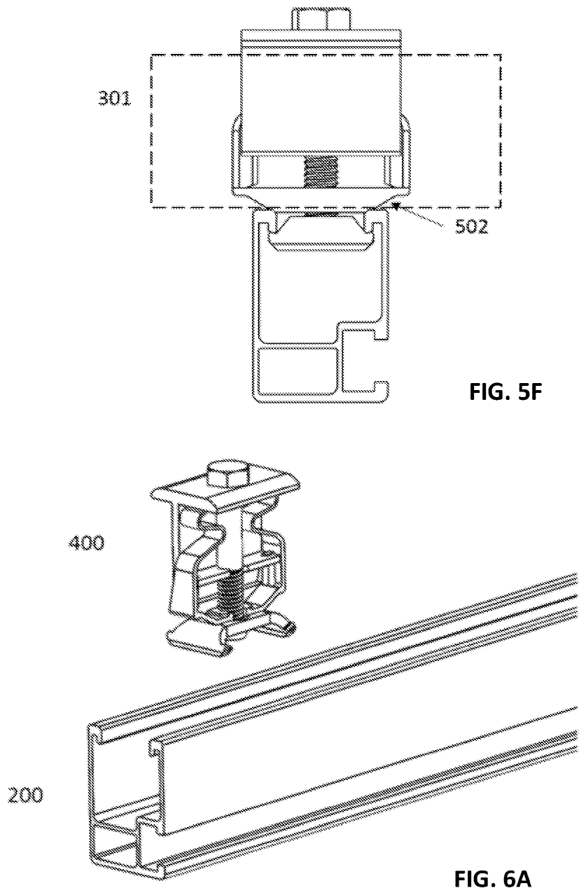

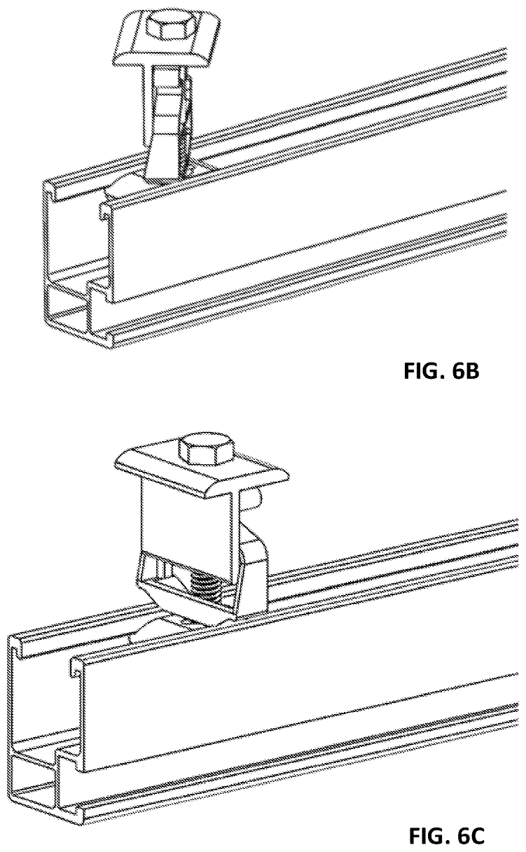

FIGS. 6A through 6C depict FIGS. 5A through 5F in an isometric view. FIG. 6A depicts FIG. 5A where the Channel Clamp 400 is position over the Rail 200. FIG. 6B depicts the FIG. 5E after the Channel Clamp 400 has been positioned inside the Rail 200, and the Top Clamp and Spring 102 are partially rotated about the primary axis of the fastener 104. In this position, the Angled Protrusion 107 of Spring 102 may have begun to engage with the top inside edges of Rail 200. FIG. 6C depicts an isometric view of FIG. 5F representing a final position of the Top Clamp 101 and Spring 102. The Angled Protrusion 107 may be shaped such that when fully engaged with a chamfer on the top inside edges of the Rail 200, the Top Clamp 101 and Spring 102 are held into a position substantially perpendicular to the length of the Rail 200.

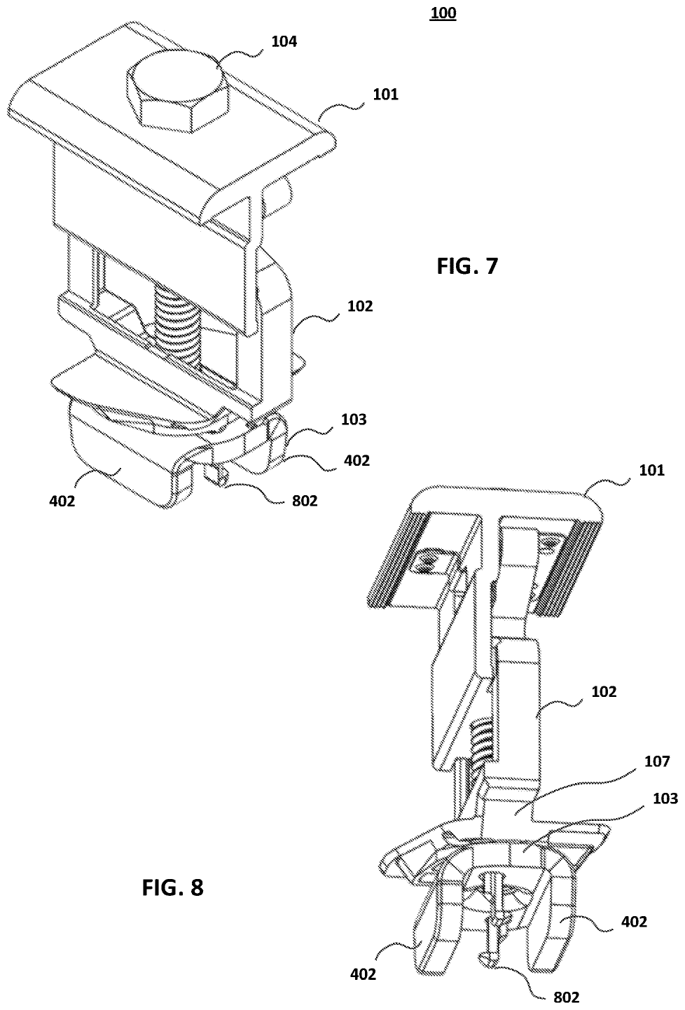

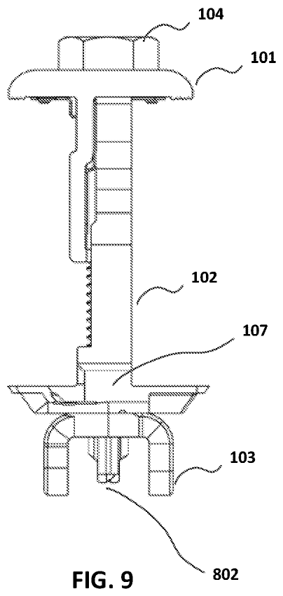

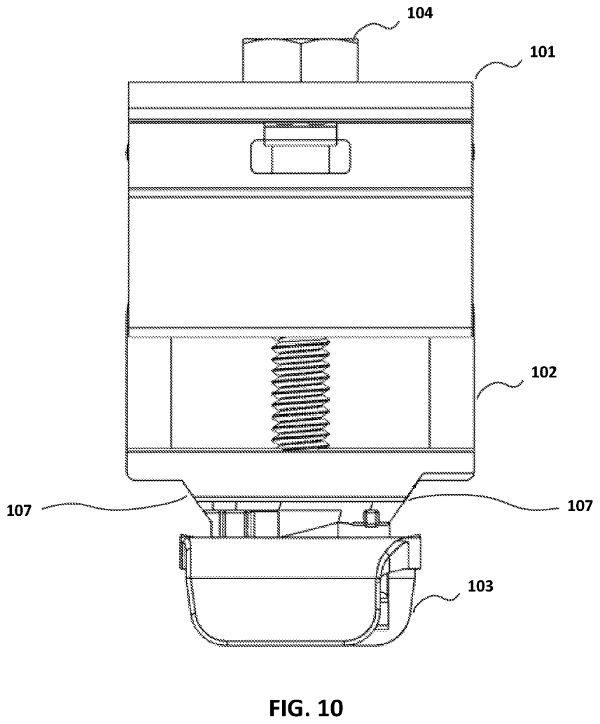

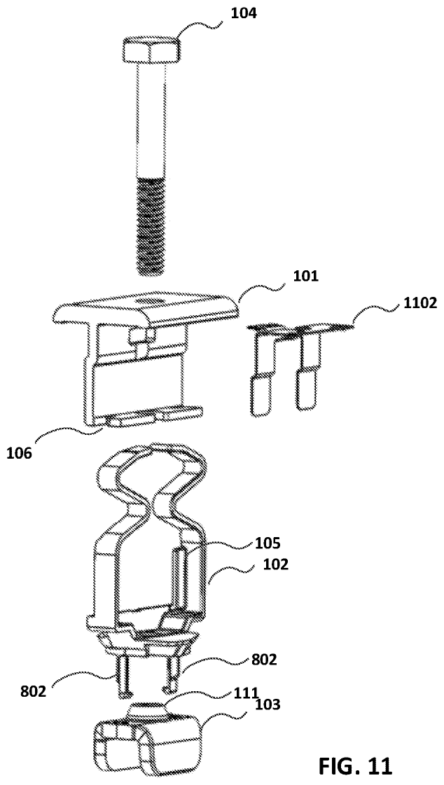

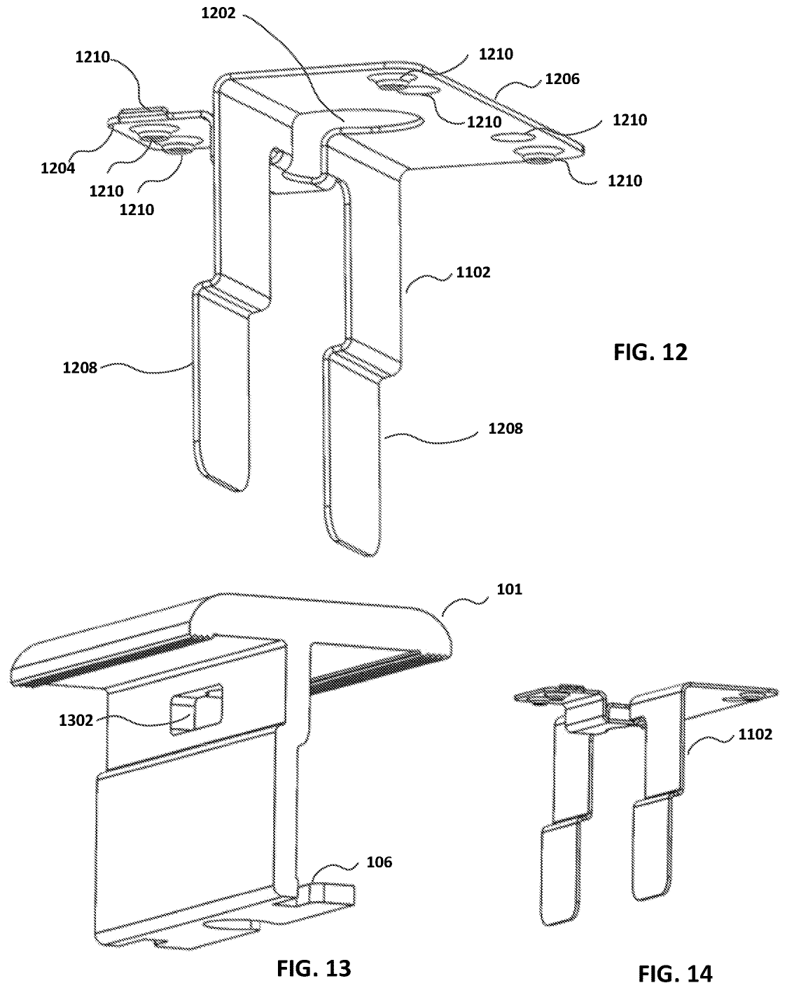

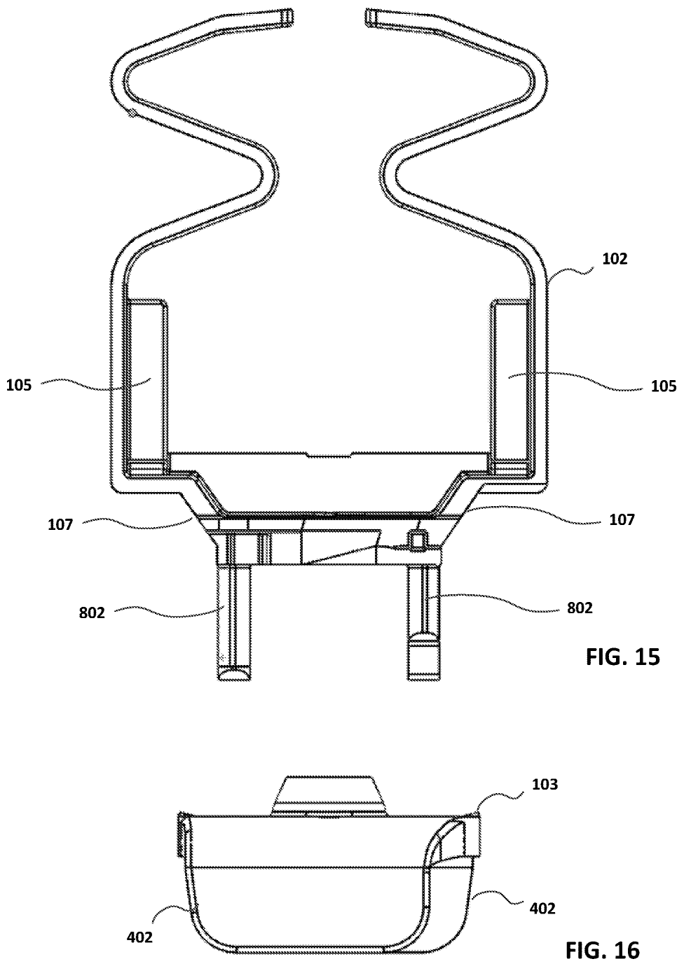

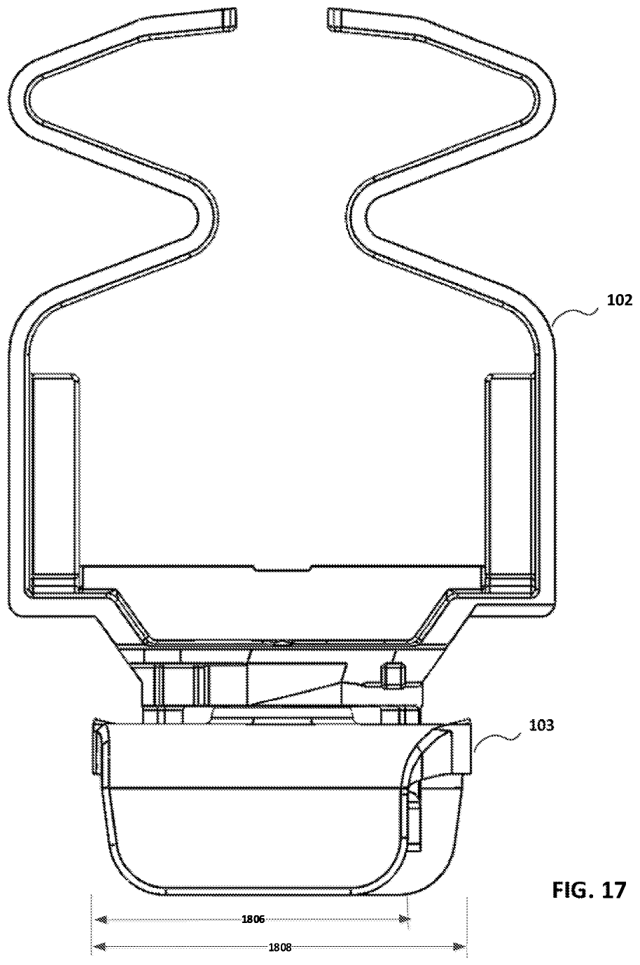

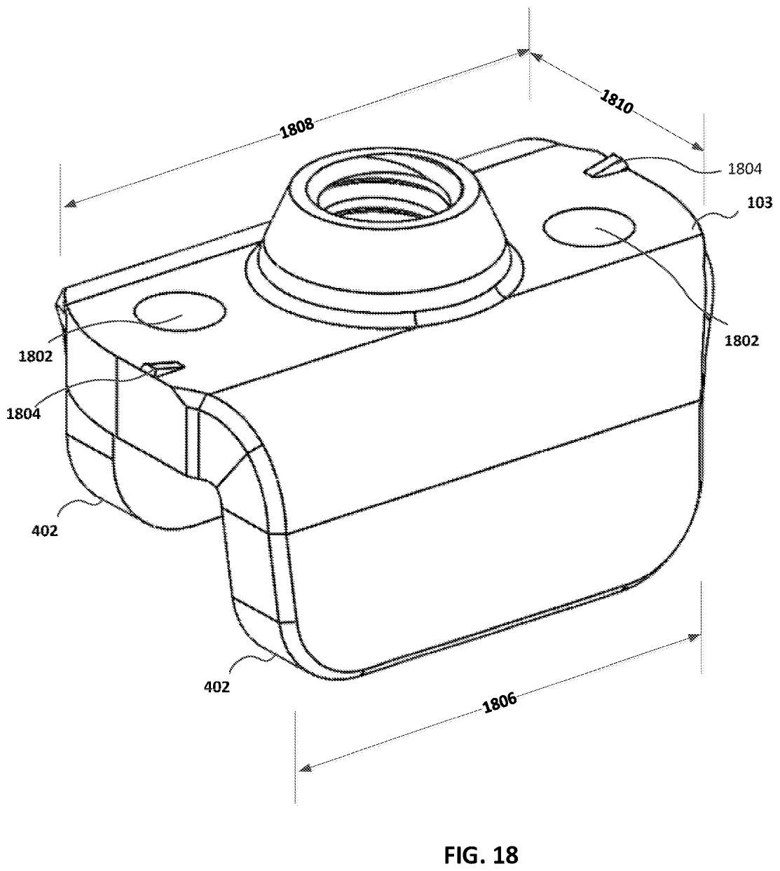

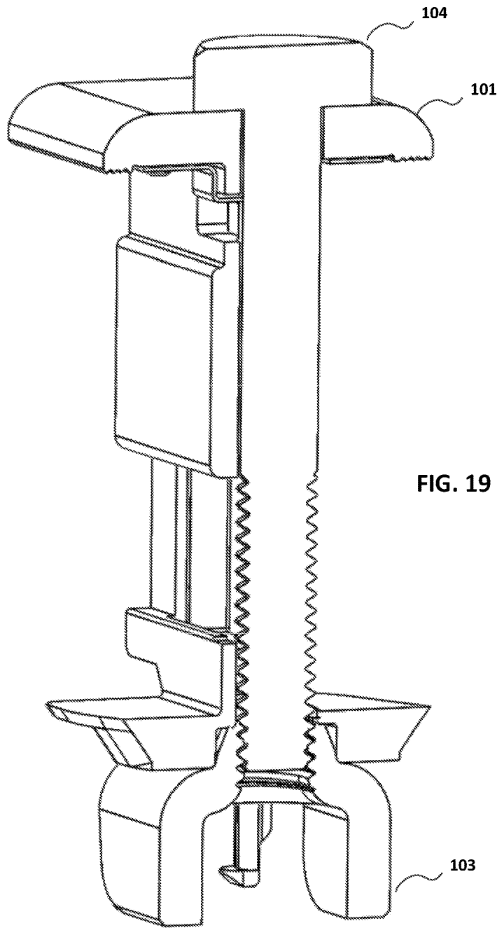

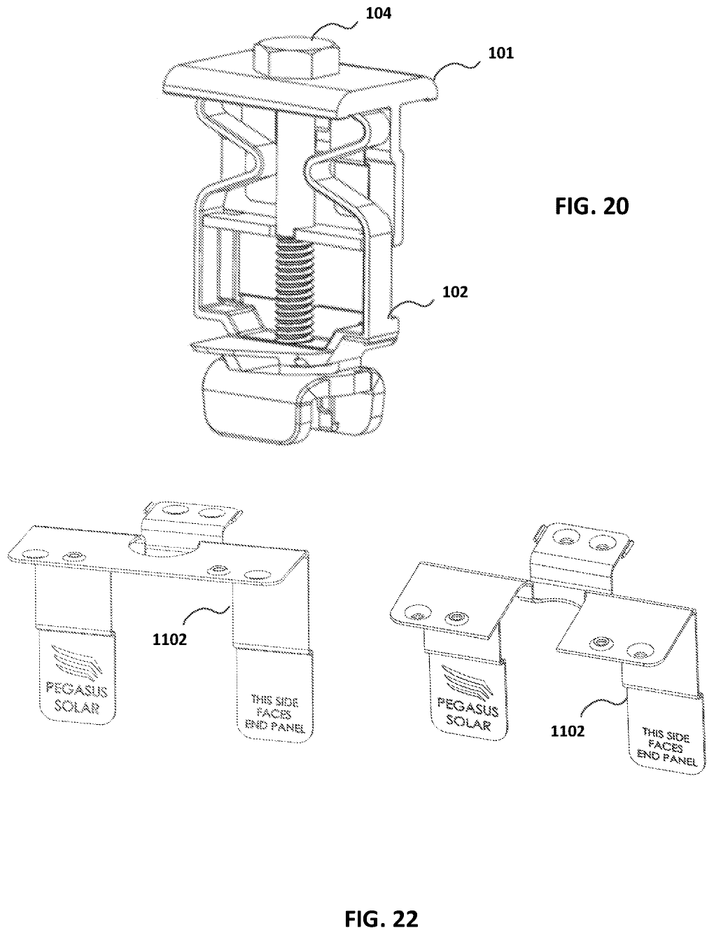

FIGS. 7-22 show examples of a second alternative embodiment of the present invention. FIG. 7 illustrates an isometric view of the twist-lock clamp 100. Twist-lock clamp 100 is an assembly of a Top Clamp 101, a Spring 102, a Bonding Clip 1102, a T-nut 103, and a fastener 104. The fastener 104 extends through one or more apertures in the Top Clamp 101, an aperture in Spring 102, an aperture in Bonding Clip 1102 and threadably engages with T-nut 103; thereby securing all components together. Spring 102 has Ribs 105 that pass-through Rib Apertures 106 in the Top Clamp 101. The interference of Ribs 105 and Rib Apertures 106 in the X and Y direction hold the Spring 102 and Top Clamp 101 in substantially the same rotational orientation around the fastener 104 if either or both the Spring 102 or Top Clamp 101 are rotated around the fastener 104. The Ribs 105 and Rib Apertures 106 may not interfere in the Z direction so as to allow the Top Clamp 101 to compress the Spring 102 and move in the negative Z direction toward the T-nut 103 while the Spring 102 remains in substantially the same position along the Z axis. Spring 102 may have an Angled Protrusion 107. The Angled Protrusion 107 may be symmetric along the central Y-plane of the Spring 102, or it may be asymmetric. The Angled Protrusion 107 may have a flat angular surface as shown, or a curved surface.

T-nut 103 may be constructed of an aluminum alloy, stainless steel alloy, carbon steel alloy, or another material with suitable strength properties. T-nut 103 has a Cone Embossment 111 formed into the T-nut 103 that provides additional threads for the fastener 104 to threadably engage.

In addition to the central threaded aperture in Cone Embossment 111, T-nut 103 also has laterally offset apertures 1802. These laterally offset apertures 1802 cooperate with nut snaps 802 in Spring 102. The cooperation of nut snaps 802 and laterally offset apertures 1802 hold the Spring 102 and T-nut 103 in substantially the same rotational orientation around the fastener 104. That cooperation also holds T-nut 103 and Spring 102 in relative position if fastener 104 and T-nut 103 become disconnected.

T-nut 103 has offset raised contact points 1804, which present a sharp engagement with Rail Prongs 202 in order to pierce a coating of the Rail 200, such as anodization or paint, in order to provide an electrical bonding path between T-nut 103 and Rail 200.

T-nut 103 has a top planar surface with a wide dimension 1808, and a narrow dimension 1810. The wide dimension 1808 of T-nut 103 is greater than the width between Rail Prongs 202 of Rail Channel 201. The narrow dimension 1810 of T-nut 103 is less than the width between Rail Prongs 202 of Rail Channel 201. The difference in dimensions 1808 and 1810 allow T-nut 103 to be inserted between Rail Prongs 202 of Rail Channel 201, and then when T-nut 103 is rotated 90 degrees, the T-nut 103 is captured in Rail Channel 201 by Rail Prongs 202. Nut Flanges 402 of T-nut 103 are also planar, and generally rectangular, having a dimension 1806 that is less than wide dimension 1808. Nut Flanges 402 are also offset so that one edge of Nut Flange 402 is generally aligned with a narrow edge of the top planar surface. This offset of Nut Flanges 402 allows T-nut 103 to rotate about 90 degrees when inserted in Rail Channel 201. Efforts to rotate T-nut 103 substantially beyond 90 degrees are prevented when the Nut Flanges 402 interfere with the walls of Rail Channel 201.

Bonding Clip 1102 has an aperture 1202, a first flange 1204, a second flange 1206, and a pair of third flanges 1208. Aperture 1202 allows fastener 104 to pass through. First flange 1204 can pass through aperture 1302 in Top Clamp 101. First and second flanges 1204 and 1206 have raised contact points 1210. The raised contact points 1210 are on both sides of second flange 1206. On first flange 1204, the raised contact points are also on both sides, although they may be different configurations. Bonding Clip 1102 may be constructed of a stainless steel alloy, carbon steel alloy, or another material with suitable strength properties. In general the strength properties of Bonding Clip 1102 are equal to or greater than the strength properties of Top Clamp 101. As illustrated in FIG. 22, Bonding Clip 1102 has labeling to indicate which side of the Clamp faces an end panel. FIG. 22 also illustrates two possible variations on the configuration of Bonding Clip 1102

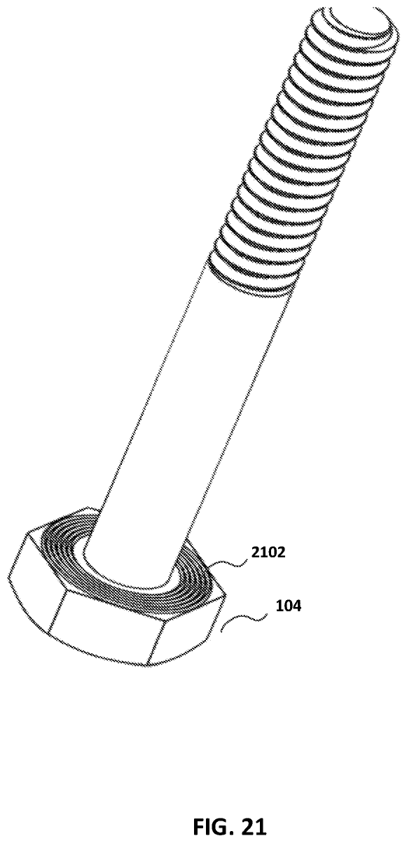

As illustrated in FIG. 21, the under surface of fastener 104 has raised rings 2102 in order to pierce a coating of top clamp 101, such as anodization or paint, in order to provide an electrical bonding path between fastener 104 and top clamp 101.

FIG. 22 illustrates lettering on a bonding clip.

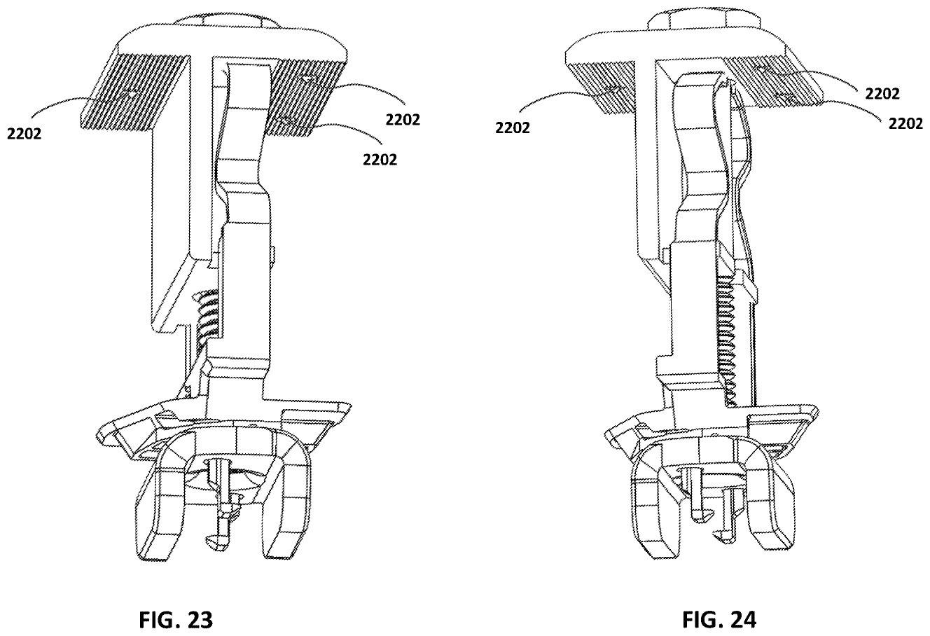

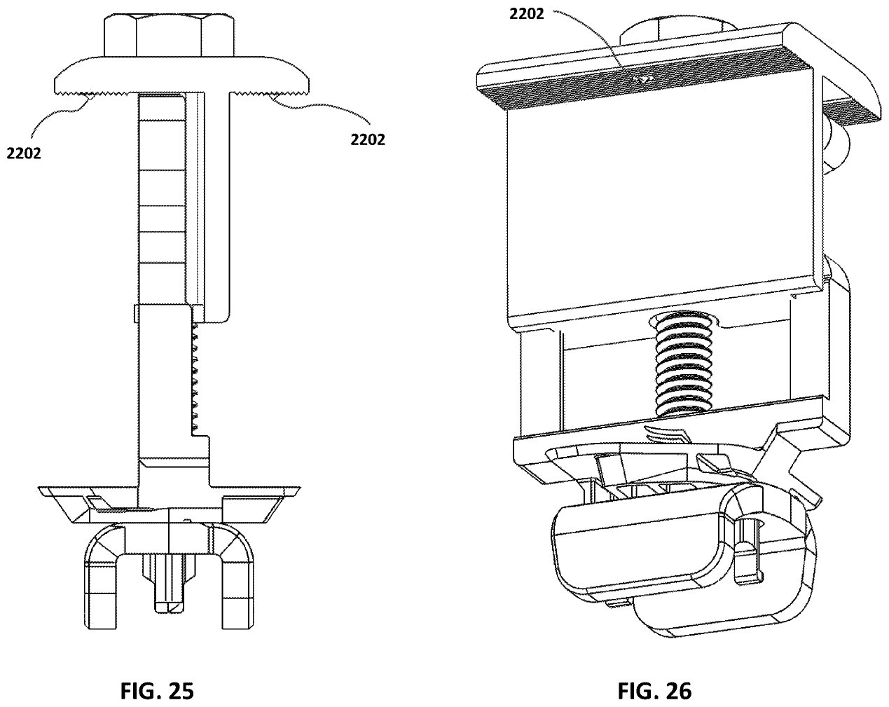

FIGS. 23-26 show examples of a third alternative embodiment of the present invention. FIG. 23 illustrates a left isometric view of the twist-lock clamp 100, and FIG. 24 illustrates a right isometric view of the twist-lock clamp 100. Many of the features illustrated and described above, are the same in this third alternative embodiment. In one difference between the earlier described embodiments, and the third alternative embodiment, the Bonding Clip 1102 is replaced by one or more Bond Pins 2202 on the lower surface of Top Clamp 101. In this third alternative embodiment, Bond Pins 2202 are inserted into the lower surface of Top Clamp 101, such as by drilling, screwing or pressing. The Bond Pins 2202 are typically stainless steel or another material that is harder than the solar module frame that is contacted by the Bond Pins when the Clamp is installed.

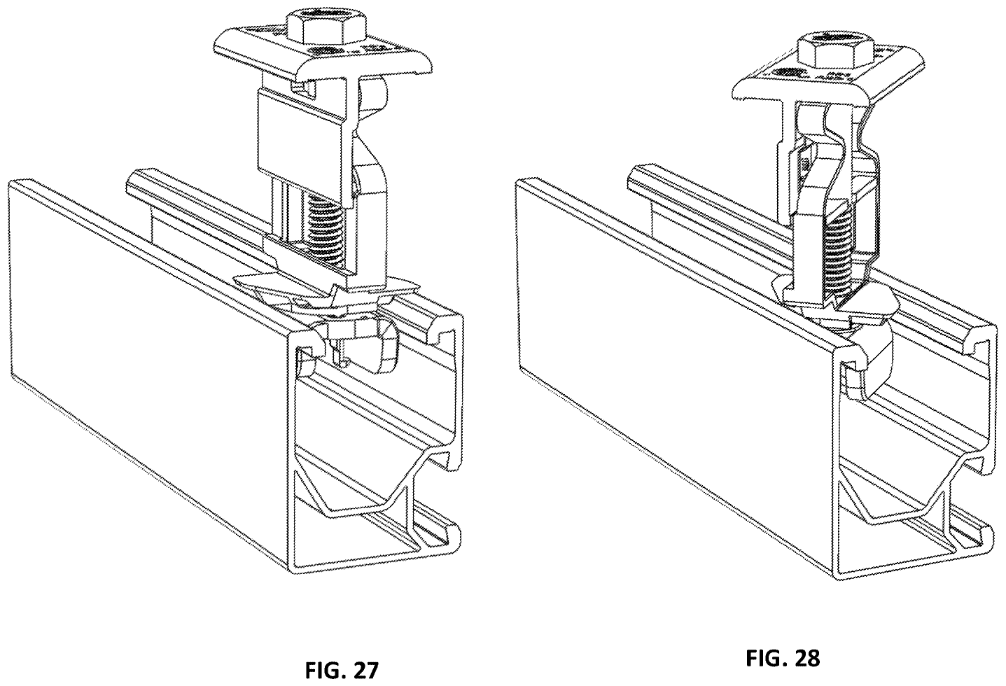

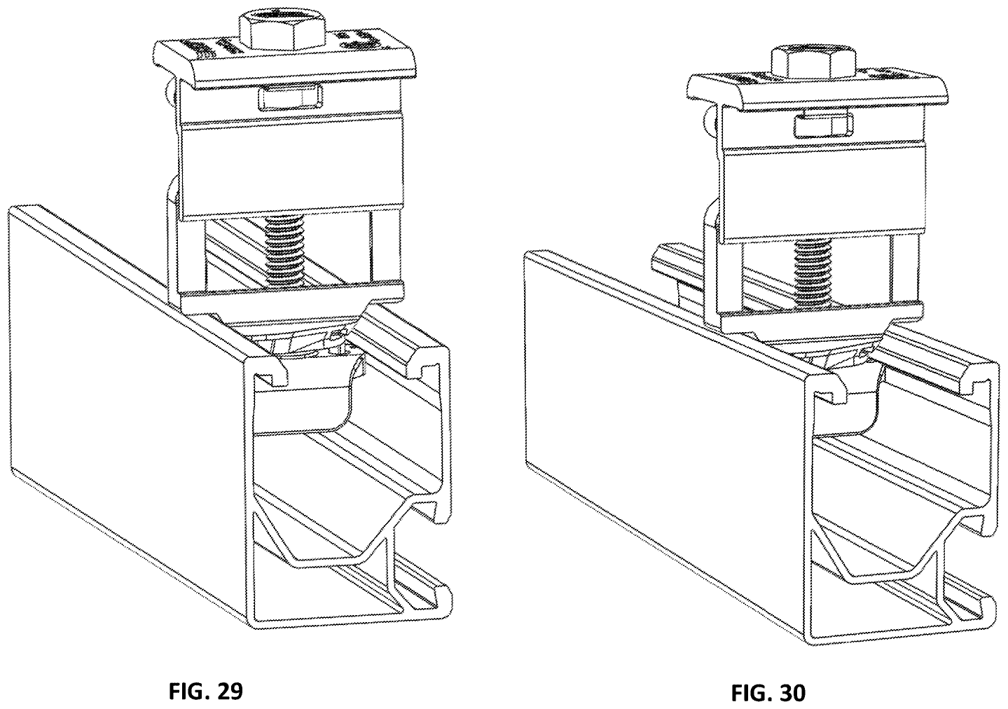

FIGS. 27-30 illustrate isometric views of the second alternative embodiment as the twist-lock clamp 100 is installed in a rail. In FIG. 27, the twist-lock clamp 100 is partially inserted in the Rail Channel 201. In FIG. 28, the T-nut is pressed down below Rail Prongs 202, and the twist-lock clamp 100 is partially rotated. In FIG. 29, the twist-lock clamp 100 is rotated into final position, and the T-nut is still pressed down below the Rail Prongs 202. In FIG. 30, the twist-lock clamp 100 is rotated into final position, and the T-nut is raised and engaged with Rail Prongs 202.

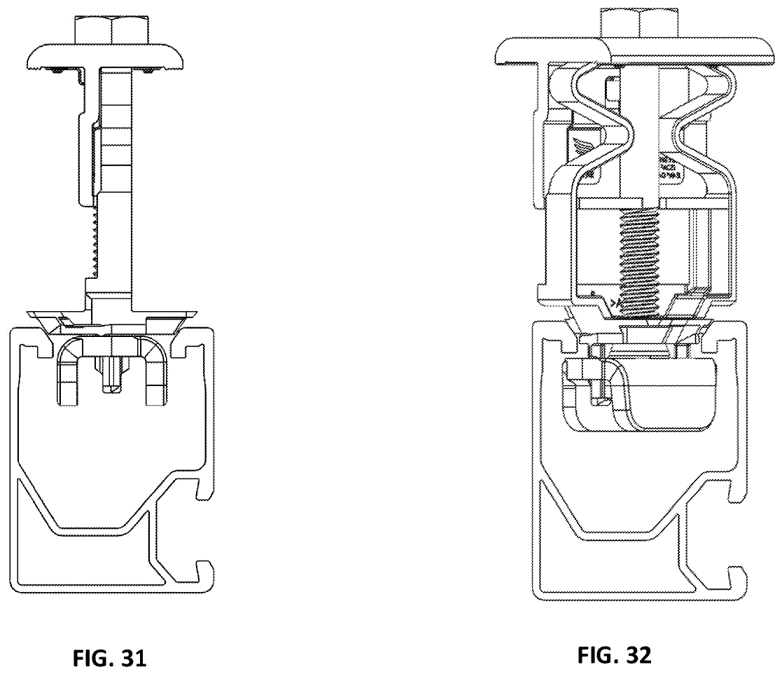

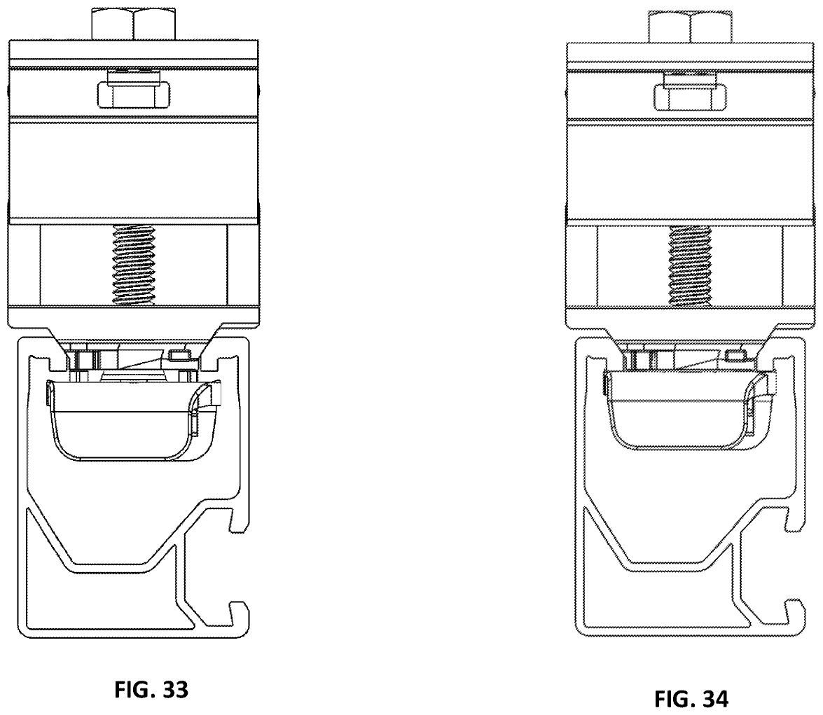

FIGS. 31-34 illustrate end views of the second alternative embodiment as the twist-lock clamp 100 is installed in a rail. In FIG. 31, the twist-lock clamp 100 is partially inserted in the Rail Channel 201. In FIG. 32, the T-nut is pressed down below Rail Prongs 202, and the twist-lock clamp 100 is partially rotated. In FIG. 33, the twist-lock clamp 100 is rotated into final position, and the T-nut is still pressed down below the Rail Prongs 202. In FIG. 34, the twist-lock clamp 100 is rotated into final position, and the T-nut is raised and engaged with Rail Prongs 202.

Although illustrative embodiments have been described herein in detail, it should be noted and will be appreciated by those skilled in the art that numerous variations may be made within the scope of this invention without departing from the principle of this invention and without sacrificing its chief advantages. For example features that appear in one embodiment of a particular figure are also applicable to embodiments that are illustrated in other figures.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

What is claimed is:

1. An apparatus comprising:
a rail configured to support one or more solar energy panels, the rail including a substantially U-shaped channel with prongs protruding inwardly and down from upper distal ends of each wall of the channel, wherein a groove is formed along an underside of each prong; and
a clamp nut that includes a substantially centrally located threaded aperture and one or more ridges, wherein the nut is configured to engage a bottom surface of the prongs rather than the groove when installed on the rail, and wherein the ridges electrically bond the rail to the nut.

2. The apparatus of claim 1, wherein the ridges are located on a surface of the nut.

3. The apparatus of claim 1, wherein the ridges are formed into the nut.

4. The apparatus of claim 1, wherein a width of the groove is greater than a thickness of the channel wall.

5. The apparatus of claim 1, wherein corners of the inwardly protruding prongs are substantially contoured.

6. The apparatus of claim 1, wherein the nut further includes downwardly protruding flanges.

7. A method of installing nuts into rails, the method comprising:
inserting a nut at an angle through an opening of a channel of a rail that includes prongs protruding inwardly and down from upper distal ends of each wall of the channel and a groove formed on an underside of each prong;
positioning the inserted nut to be substantially parallel to a top surface of the rail;
engaging the nut to the prongs, wherein the nut engages a bottom surface of the prongs rather than the groove; and
adjusting the nut into a position along a length of the rail.

8. The method of claim 7, wherein the nut includes one or more ridges located on a surface of the nut, and wherein engaging the nut to the prongs results in the ridges electrically bonding the rail to the nut.

9. The method of claim 7, wherein the nut includes one or more ridges formed into the nut, and wherein engaging the nut to the prongs results in the ridges electrically bonding the rail to the nut.

10. The method of claim 7, wherein engaging the nut to the prongs is based on corners of the inwardly protruding prongs being substantially contoured to a shape of the nut.

11. The method of claim 7, wherein the nut further includes downwardly protruding flanges, and wherein engaging the nut to the prongs includes engaging the downwardly protruding flanges to the prongs.

12. A method of installing nuts into rails, the method comprising:
inserting a nut that includes a threaded aperture through an opening of a channel of a rail that includes one or more prongs;
rotating the nut around an axis of the threaded aperture so that a length of the nut extends underneath the prongs, and wherein the rotated nut engages a bottom surface of the prongs rather than the groove; and
adjusting the nut into a position along a length of the rail.

13. The method of claim 12, wherein the nut includes one or more ridges located on a surface of the nut, and wherein engaging the nut to the prongs results in the ridges electrically bonding the rail to the nut.

14. The method of claim 12, wherein the nut includes one or more ridges formed into the nut, and wherein engaging the nut to the prongs results in the ridges electrically bonding the rail to the nut.

15. The method of claim 12, wherein engaging the nut to the prongs is based on corners of the inwardly protruding prongs being substantially contoured to a shape of the nut.

16. The method of claim 12, wherein the nut further includes downwardly protruding flanges, and wherein engaging the nut to the prongs includes engaging the downwardly protruding flanges to the prongs.
